(19) United States
(12) Patent Application Publication
(10) Pub. No.: US 2005/0014122 A1
(43) Pub. Date: Jan. 20, 2005

(54) Project management system for education

(76) Inventors: Ilene G. Ruvinsky, Kirkland, WA (US); Katherine Majus, Kirkland, WA (US); Lindsay Bath, Kirkland, WA (US)

Correspondence Address: Bruce H. Johnsonbaugh;Eckhoff & Hoppe, 333 Sacramento Street, San Francisco, CA, 94111, US

(21) Appl. No.: 10/875,565

(22) Filed: Jun. 24, 2004

Related U.S. Application Data
(60) Provisional application No. 60/482,369, filed on Jun. 25, 2003.

(51) Int. Cl. G09B 3/00

(52) U.S. Cl. 434/350

(57) ABSTRACT

An Internet based system for tracking and managing educational projects is provided wherein participating students in an educational institution are assigned one or more projects, the projects are to be planned and information delivered by the students for review and/or approval by participating faculty or others. A central computer memory for storage is provided, access for participating students to the memory is provided, access in the central storage is provided for participating students and faculty and other authorized persons to submit, view, edit, or delete deliverable information, deadlines are automatically tracked and notices are automatically sent out to participating faculty when project deliverable information has been submitted for approval and the system automatically records, stores and notifies participating students of faculty approval or disapproval.

### CROSS-REFERENCE TO RELATED APPLICATION

This application claims the benefit of and priority from U.S. provisional application Ser. No. 60/482,369 dated Jun. 25, 2003.

### BACKGROUND OF THE INVENTION

1. Field of Invention

This invention is a software application system that automates the project management and tracking processes of student project work, automates the work approval process and communicates information to project participants.

2. Background of the Invention

Project-based learning is, as the name suggests, a method of learning by completing some form of project. The word “project” as used herein is defined as a temporary endeavor undertaken to create a unique product, service or result. It is distinctly different from learning by other, more traditional means (e.g. textbooks, classroom teaching), because it involves a student taking responsibility to apply existing knowledge to, and gain new knowledge and experiences from his or her project. Project-based learning programs exist in education institutions at all levels (elementary, middle, high-school, college).

There are three (3) levels of project-based learning within an institution. The first, the Program, is the institution level itself. Institution administrators set, implement and monitor the performance of the entire program (i.e. all projects, and all participants). They have responsibility for setting goals, policies, standards, guidelines, assessment criteria.

The second is the supervisory level. Faculty members are assigned responsibility for supervising, guiding, and advising (typically groups of) students with their projects. Faculty members are also responsible to the institution for ensuring student adherence to policies, standards, guidelines, and meeting goals. Another key responsibility for faculty members is approving students' project work. The institution can also designate other people to be responsible for review and/or approving students' work (e.g. parents, outside advisors, community members, etc).

The third is the student project level. Students are responsible for managing all aspects of their own projects (e.g. costs, schedules, materials, facilities, etc) and successfully completing their projects. They must submit their project work for approval by supervisory-level people.

As with almost all forms of learning, project-based learning still requires students to submit their project work (called “deliverables” in project management parlance) for approval. The word “deliverable” is defined as any measurable, tangible, verifiable outcome, result, or item that must be produced to complete a project, or part of a project. Likewise, approvers approve deliverables, or ask the student to rework and re-submit their work for approval. There are many fundamental similarities between education-based projects and those in business. Projects are typically completed in discrete steps or phases, and include budgets, schedules, forms for submission and approval, deadlines, communication, tracking, progress reporting and closure.

At the program level, institutions set and communicate goals, policies, standards and guidelines using a variety of methods. These include mailings, flyers, emails, announcements, booklets, bulletins and the like. Often, not all participants end up receiving the communications, and there is no single repository of program information accessible by participants. Participants therefore have inconsistent ideas about the program's requirements, and are not “on the same page” throughout the program. In addition, because of these process and information-related problems, education administrators cannot easily monitor or manage the performance of the project-based learning programs under their jurisdiction. In addition, the institution can be legally challenged in cases where it fails students' projects. There are no tools built for, and dedicated to, supporting project-based learning at the program level.

Poor, very limited, non-specific and non-integrated IT application support for projects and programs. cannot easily monitor or manage the performance of the project-based learning programs under their jurisdiction. In addition, the institution can be legally challenged in cases where it fails students' projects. There are no tools built for, and dedicated to, supporting project-based learning at the program level.

At the supervisory level, Faculty members rely on methods of communication similar to those used at the program-level, plus face-to-face sessions with students. Currently, students typically submit their project deliverables to approvers in hard-copy format, or a combination of hard-copy and electronic personal computer files. Similarly, approvers send the deliverables back to students, with commentary, in hard-copy. In addition, project-related information, such as due dates, assessment criteria, institution policies, guidelines and standards and related details are communicated via hard-copy or a combination of hard-copy and electronic personal computer files.

These administrative overheads take Faculty members' time away from teaching. Information resides in project participants' notebooks, files, individual computer systems, and in other locations. It is not easily accessible by the many people who require it. Over the course of a project (the duration of which can be one year), the volume of information, in all its forms, becomes difficult to manage. Plagiarism is also difficult to determine. No aspects of project management at the supervisory-level are supported by purpose-built tools.

At the student project level, inconsistencies in deliverable content and quality exist. Many students lack basic project management skills (e.g. organizing, scheduling, budgeting, etc) and tools, thus increasing their likelihood of failing their projects. They are thus ill-prepared to enter the business or academic worlds. Sound project management techniques are a life-skill. While students currently have a selection of popular software programs to aid them in individual project components (e.g. spreadsheets for budgets, word processing for reports), there are no purpose-built software tools with which to manage all project components.

In summary, the major problems being experienced by all participants in project-based learning programs are: insufficient communication between participants, and inadequate project tracking and control. These processes are typically labor and paper-intensive, inconsistent and difficult to manage. They enjoy only poor, very limited, non-specific and non-integrated IT computer support in education institutions that use computer technology. Significant time is spent by project participants in simply managing forms (content, filing, tracking, collating, distributing), project status, participants, information and resources.

### BACKGROUND OF INVENTION—OBJECTS AND ADVANTAGES

The primary object of our invention is to develop and provide an integrated, world wide web (WWW)-enabled (or Internet based), project tracking, management and communication system. It will be based on proven project management disciplines and be used by education institutions and participants of project-based learning programs. The system contains the following general features and functions:

At the Program Level—Manage the Overall Program

1. Set up and maintain complete on-line project-based learning program information (including assessment criteria, calendar of events, policies, guidelines and standards, etc), tailored to each education institution.

2. Set up and maintain due dates for student project deliverables and for approvals.

3. Load and maintain users within the software tool.

4. The ability to involve parents, outside advisors and community participants.

5. On-line information on all projects and participants.

6. Monitor and report on program performance.

7. End-of-year archive of all project work.

At the Supervisory Level—Manage Multiple Projects

1. Review students' deliverables on-line and electronically send them back to students with comments, either as approved or asking students to rework the deliverables.

2. System-maintained status of all deliverables in the process, with automatic status notification.

3. A lookup function to view and contact all participants in approvers' students projects.

4. Track student work-in-progress, including past due work.

5. Track approvals, including those that are past due.

6. System-maintained ongoing history of students' work, complete with approvers and other participants' comments.

7. Connection to a plagiarism tool, to help ensure students' work is their own.

8. Printable deliverables for approvers and other participants who do not have internet access, or for other special reasons.

At the Project Level—Manage Single Projects

1. An automated, four (4)-step process to create, edit and submit deliverables and other project work on-line for approvals.

2. A system-maintained status of all deliverables in the process, with automatic status notification.

3. A lookup function to view all participants in a student's project.

4. Track work-in-progress, including past due work.

5. Track approvals, including those that are past due.

6. The ability to submit personal electronic files.

7. A research facility.

8. Project scheduling and budgeting facilities.

At all Levels

1. A calendar of important project dates throughout the year.

2. Easy-to-use, with on-line help, instructions and frequently asked questions (FAQs).

3. Email and messaging capabilities among project participants.

4. Email notification of actions required.

5. Login and password security.

6. Available from any computer and location that provides internet connection.

### SUMMARY

In accordance with the present invention, this system meets the problems and needs of education institutions and participants that are specific to all three management levels of project-based learning programs.

### DRAWINGS—FIGURES

FIG. 1 shows the three (3) levels in managing project-based learning programs. The Program-level, the Supervisory-level, and the Project-level.

FIG. 2A shows the 4-step project management process that, together with FIG. 3, underpins my invention, together with the deliverables from each step. These deliverables are part of the work students must complete, then submit for approval. Students cannot continue from one step to the next until the previous step is approved.

FIG. 2B shows the main components contained in each deliverable in the 4-step process.

FIG. 3 shows the approval/rework process for students' deliverables to and from approvers which, together with the 4-step process (FIG. 2A), underpins the invention.

FIG. 4 shows in schematic form the major components of the invention.

DRAWINGS--REFERENCE NUMERALS

| | | | |
|---|---|---|---|
| 4 | program-level management | 6 | supervisory-level management |
| 8 | project-level management | 10 | project step 1 and its resulting |
| | | | deliverable |
| 12 | project step 2 and its resulting | 14 | project step 3 and its resulting |
| | deliverable | | deliverable |
| 16 | project step 4 and its resulting | 18 | project step 1 deliverable |
| | deliverable | | components |
| 20 | project step 2 deliverable | 22 | project step 3 deliverable |
| | components | | components |
| 24 | project step 4 deliverable | 26 | student submits deliverable and |
| | components | | approver notified |
| 28 | approver #1 approves | 30 | student notified of approver's |
| | deliverable or requests rework | | decision |
| 32 | approver #n approves | 34 | student notified of approver's |
| | deliverable or requests rework | | decision |
| 36 | student changes deliverable | 38 | software tool scheduling/ |
| | and resubmits for approvals | | calendar feature |
| 40 | software tool budgeting | 42 | software tool institution policies |
| | feature | | feature |
| 44 | software tool electronic | 46 | software tool reporting feature |
| | forms feature | | |
| 48 | software tool submissions/ | 50 | software tool security feature |
| | approvals feature | | |
| 52 | software tool help feature | 54 | software tool project tracking |
| | | | feature |
| 56 | software tool research/ | 58 | software tool plagiarism |
| | archiving feature | | scanning feature |
| 60 | software tool communi- | 62 | program-level users - education |
| | cations feature | | Institution administrators |
| 64 | supervisory-level users - | 66 | project-level users - students |
| | approvers and other | | |
| | participants | | |

### DETAILED DESCRIPTION

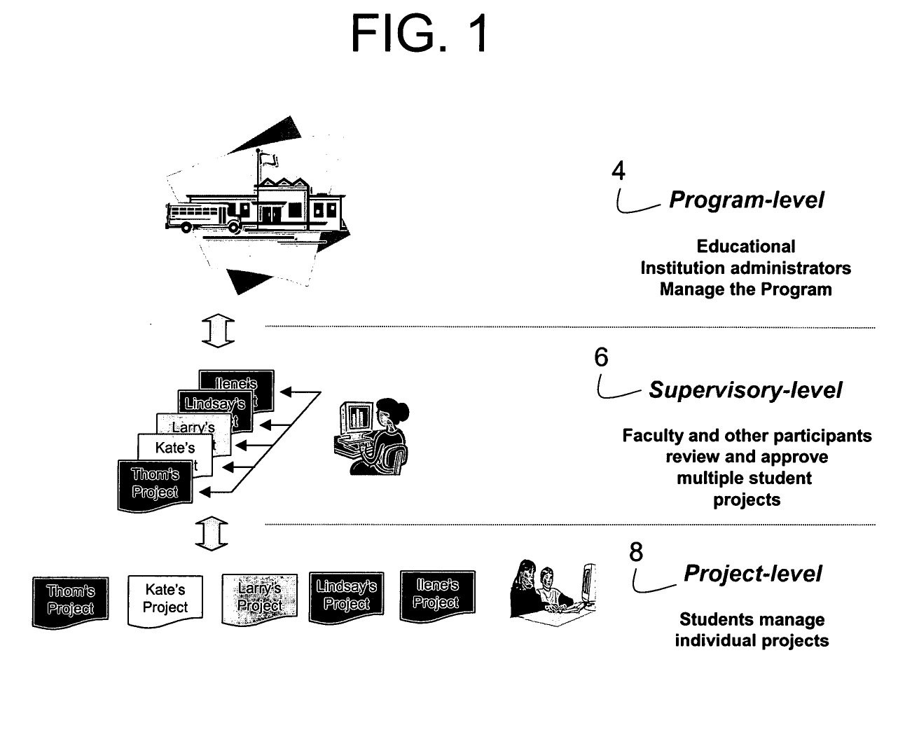

FIG. 1 shows the 3 management levels in a project-based learning environment. At the Program-level 4, institution goals, policies, standards, guidelines, due dates, assessment criteria and other program-wide issues are determined. These apply to all projects. At the Supervisory-level 6, Faculty members and others such as parents and outside advisors are responsible for providing guidance and direction to multiple students, approving student deliverables, and ensuring student project adherence to institution polices and standards. At the Project-level 8, students are responsible for completing and submitting their project deliverables and associated work.

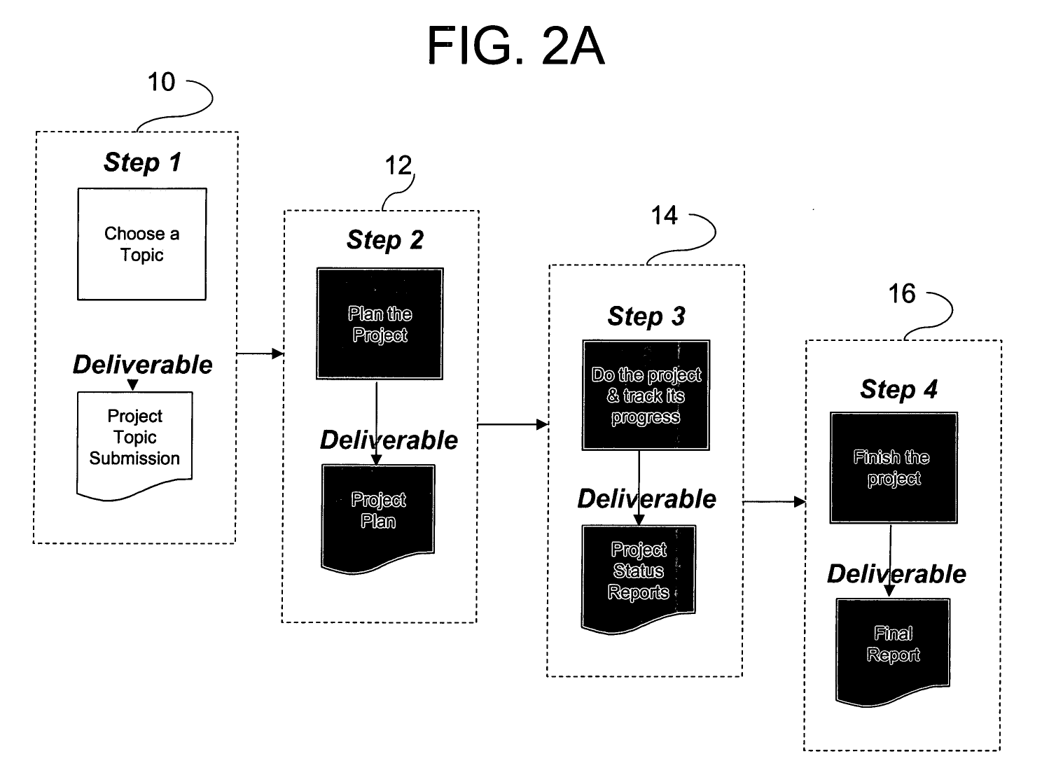

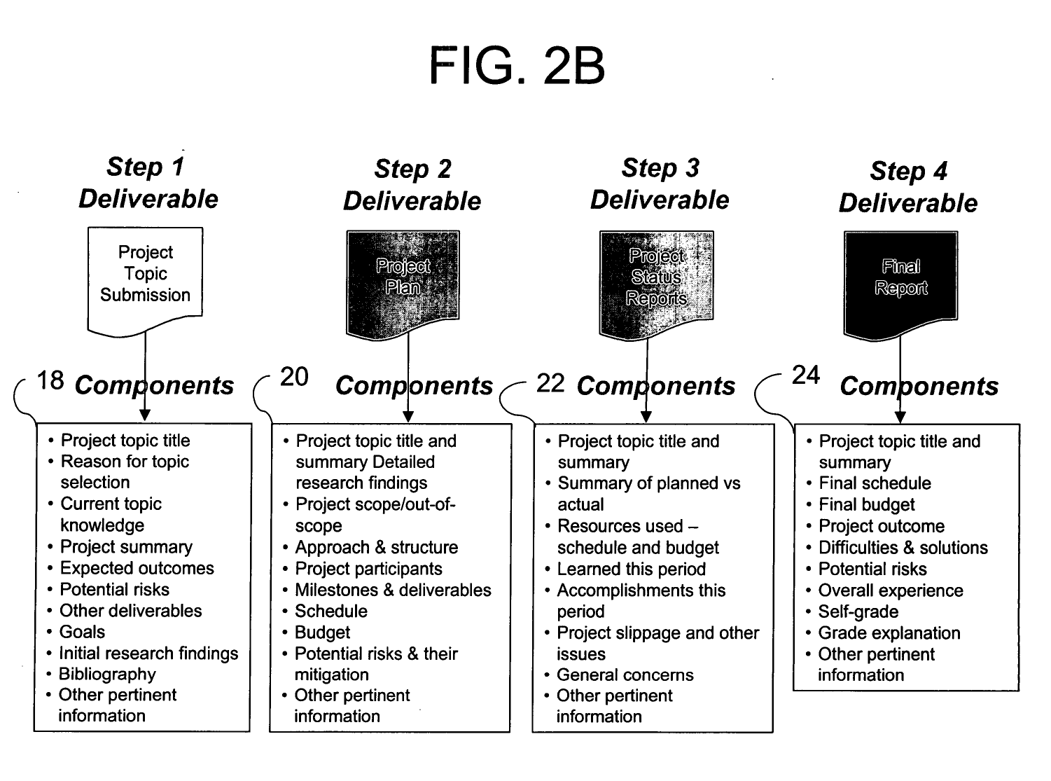

FIG. 2A shows the 4 sequential steps in a project. All deliverables are submitted electronically by students to approvers, and must be approved, before students can progress to the next step.
Step 1 10 a project is assigned to, or selected by a student. The resulting deliverable is the “Project Topic Submission.”
Step 2 12 the student plans the elements of how to undertake the project. The resulting deliverable is the “Project Plan.”
Step 3 14 the student commences the project, and regularly reports his/her progress to approvers. The resulting deliverables are “Project Status Reports.”
Step 4 16 the student completes his/her project. The resulting deliverable is the “Final Report.”

FIG. 2B shows the Project Topic Submission deliverable components 18, the Project Plan deliverable components 20, the Project Status Report deliverable components 22 and the Final Report deliverable components 24.

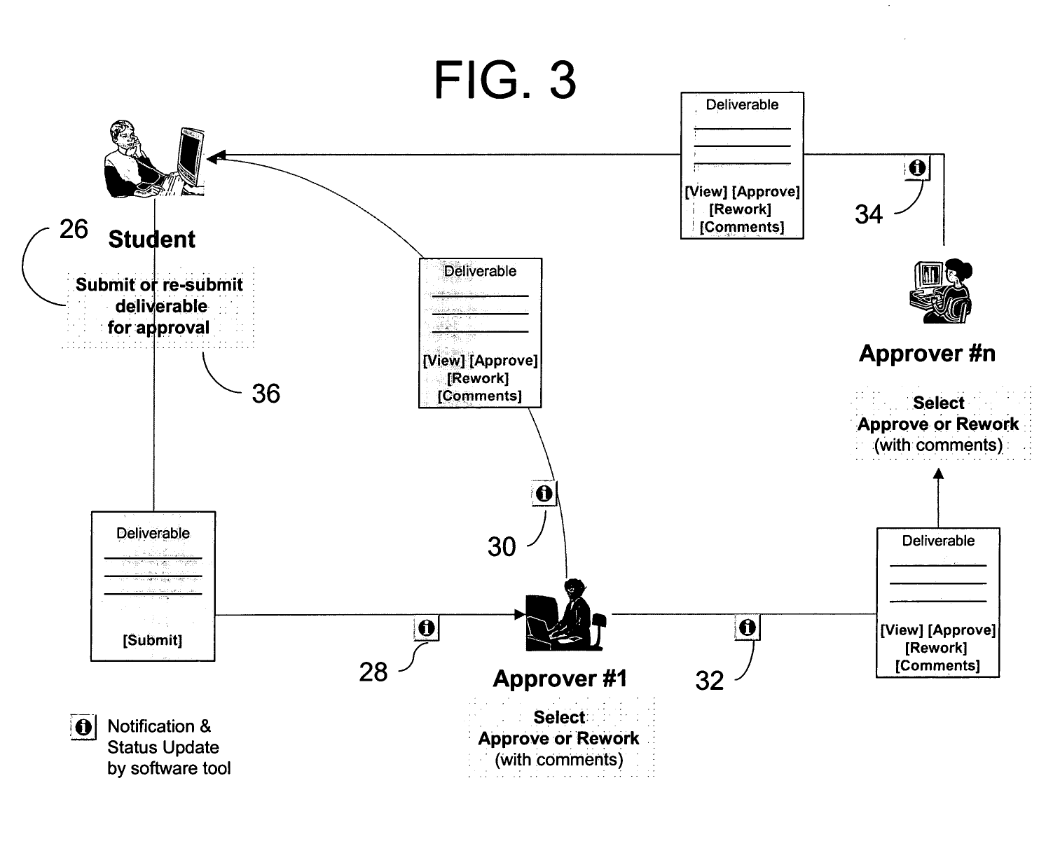

FIG. 3 shows the system's automatic deliverable status notifications from and to students and approvers. A student submits a deliverable and is notified 26 of its successful submission. Approver #1 is notified 28 that the student deliverable is waiting for his/her approval. The student is notified 30 if the deliverable is approved or requires rework. Once approved by Approver #1, Approver #n is notified 32 that the student deliverable is waiting for his/her approval. The student is notified 34 if the deliverable is approved or requires rework. If the deliverable is not approved by any Approver, the student edits the document and resubmits it 36 for approval. This is an iterative process that will occur until all Approvers approve the deliverable (as explained above). The system can handle more than 2 approvers.

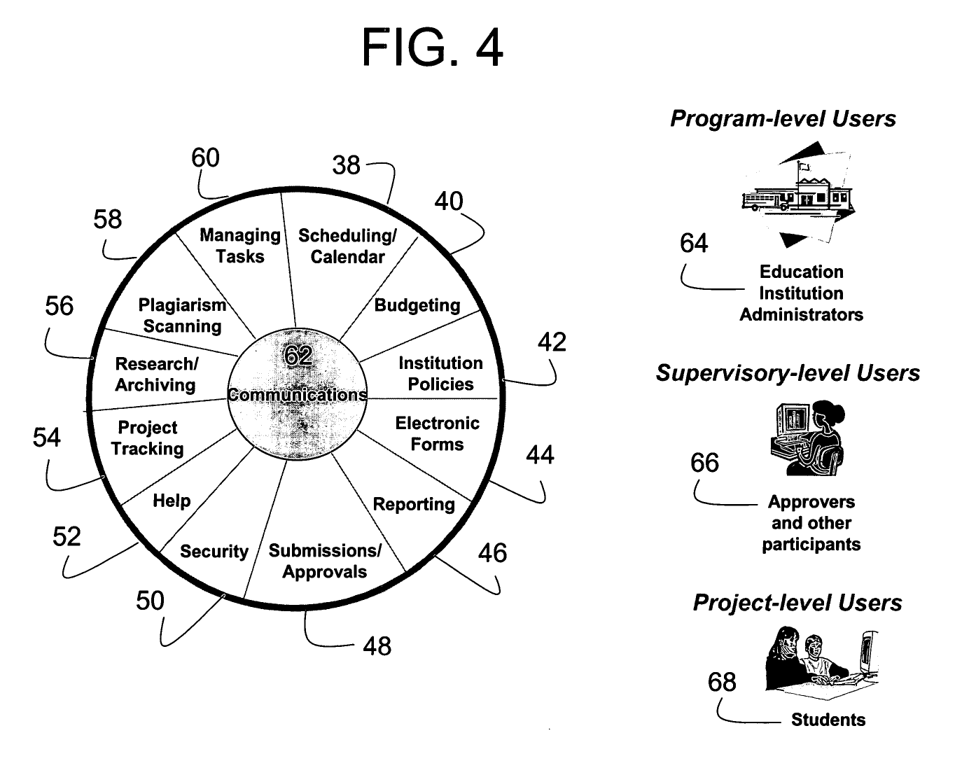

FIG. 4 shows an abstract summary of the major features and users of the system. “Scheduling & Calendar” 38 is a feature that displays a standard calendar on-line containing the due dates for submission of students' deliverables. The calendar also displays the due dates for deliverable approvals for each Approver (#1-#n). Other important dates can also be displayed.

“Budgeting” 40 is a feature that enables students to enter estimated record project costs into the system. Students can also enter actual costs into the software tool as they commence their project, and until the project is completed.

“Institution Policies” 42 is a feature that enables education institutions to enter their policies, guidelines, standards, assessment criteria, and any other information into the system. This information is accessible to all users.

“Electronic Forms” 44 are deliverables, the processing of which is described in part, above. The Electronic Forms feature also allows students to include their own electronic files (such as documents, spreadsheets, photographs, drawings and other project-related artifacts) to approvers.

“Reporting” 46, as the name suggests, is a feature enabling institution administrators to run program performance and other reports from the system.

“Submissions/Approvals” 48 is a feature that has been described under FIG. 3 (above).

“Security” 50 is a feature that controls users' access to the system and its features.

“Help” 52 is a series of features that comprise a glossary of terms used in the system and project management, questions-and-answers to the most frequently asked questions, and on-line instructions and examples.

“Project Tracking” 54 is a feature that enables the system to automatically track the status of student deliverables, and of deliverable approvals by the due dates of each. Status is displayed to students, approvers and all authorized users of the software tool. Approvers are also notified by email of the approval actions required of them.

“Research/Archiving” 56 is a feature that enables students to search previous students' project topic summaries for ideas, and to receive an archive of their own project work at project-end.

“Plagiarism Scanning” 58 is the connection from the software tool to a feature that enables approvers to determine whether students' work has been illegally copied from one or more sources.

“Managing Tasks” 60 is a feature that enables students to break their project down into discrete categories of tasks, discrete tasks, to enter estimated and actual start and complete dates and estimated and actual hours involved in task completion. The feature also enables users to enter a description of the task they do and a reflection on what they learned from doing the task.

“Communications” 62 is a feature that enables students, approvers and other authorized users to communicate with each other from within the system. The feature also enables users to generate email messages to other users of the system.

In addition, the feature automatically tracks and notifies users of deliverable status and due dates. Finally, inherent in the communications feature is the ability for suitably equipped and authorized users to access the software tool from any internet-capable location.

“Education Institution Administrators” 64 are Program-level users, “Approvers and other Participants” 66 are Supervisory-level users and “Students” 68 are project-level users of the system. The relationships between users can be configured within the system.

OPERATION

All authorized users are assigned a unique ID and password by an administrator for access to the system. The system will run on personal computers configured with an internet browser and with connection to the internet. Users access the features listed above, appropriate to their user type. This Section explains the system's operation by taking the reader through a project, as though the reader was a participant in each user group.

1) All Users

After logging into the system, all users can access the following features by clicking on predefined areas of the screen. They enter information where requested, and click on the predefined screen area (e.g. a button, graphic icon, menu item, tab or similar) that is appropriate to the action they wish to perform. Each feature is displayed on one or more separate screens:
a) Information on the institution's project requirements
b) Research project topics and summaries of previous students
c) Detailed information on the institution's requirements (with samples) of, and instructions for completing project deliverables.
d) Sending messages to other project participants from within the tool.
e) A calendar containing due dates for project deliverables and approvals.
f) View all the participants in their project, with contact details and the facility to send emails.
g) A selection of questions-and-answers to the most frequently asked questions.
h) A glossary of terms used in the software tool and in project management.
I) Update their personal details (contact information, nickname, etc) and password.
j) Contact by email, a person responsible for providing solutions to problems encountered in the software tool.
k) A list of activities that need to be completed by given dates.
l) A list of activities which are past due.

2) Students

Students are at the project-level of project-based learning programs. When a student logs on, a student-specific screen is displayed. The features described under “1) All Users” (above) can be accessed, or the student can go directly to their project work. The student selects an area on their screen (e.g. a button, graphic icon, menu item, tab or similar) that corresponds to the project step and associated deliverable they have to complete. These are:

Step 1: Choose a Topic—Project Topic Submission deliverable 10

Step 2: Plan the Project—Project Plan deliverable 12

Step 3: Report Progress—Project Status Report deliverables 14

Step 4: Finish the Project—Final Report deliverable 16

The system tracks and displays the status of all deliverables. Deliverable status can be one of the following:
a) Not started
b) In progress, but not yet submitted
c) Submitted and waiting for Approver #n's approval
d) Approved by Approver #n and waiting for Approver #m's approval
e) Approved (by all Approvers)

An additional status area is displayed showing deliverable due dates and whether a deliverable is past due.

At the beginning of a project, the student selects Step 1: Choose a Topic. A student who is assigned a topic would also use the following process. A screen displays the Project Topic Submission deliverable form 18, which has instructions on what the student is required to do, plus areas for the student to enter the required information. The student can save and edit the deliverable at any time. When the student completes the deliverable, either with or without input from parents or outside advisors, he/she submits it for approval 26. The student is notified 30 when the deliverable has been approved or requires rework. If the student is notified that rework is required, the student must edit the deliverable and re-submit it 36. At Step 2 of a project, the student selects Step 2: Plan Project. A screen displays the Project Plan deliverable form, which has instructions on what the student is required to do, plus areas for the student to enter the required information.

The student follows the same process of saving, editing, and submitting the Project Plan for approval as described for the Project Topic Submission. The system tracks and notifies the deliverable's status in the same way as for the Project Topic Submission.

The Project Plan also follows the same approvals and rework process as the Project Topic Submission. This is an iterative process.

At Step 3 of a project, the student selects Sept 3: Project Status Reports. Project Status Reports are deliverables that the student submits regularly to track and report progress once he/she commences the project. They are also used to compare a student's actual progress against the estimates the student submitted in the Project Plan.

Thus, a student will, over the course of his/her project, complete and submit for approval, multiple Project Status Reports. While the deliverable content is different, creating, saving, editing and submitting a Project Status Report is the same as that for Project Topic Submissions and Project Plans. In addition, the same approval and rework processes and status notifications are used.

Step 4: Finish Project is the student's final step. Completion, submission and approval of the Final Report marks the conclusion of the student's project. Creating, saving, editing and submitting a Final Report is the same as that for Project Topic Submissions, Project Plans and Project Status Reports. In addition, the same approval and rework processes and status notifications are used.

The system may be designed to allow students to begin work on Step 2, for example, before all approvals have been entered for Step 1. Alternately, the system may require that all approvals for a particular Step be entered before the students may use the system for the next Step.

3) Approvers

Approvers are at the supervisory-level of the program, and are designated within the system to one or more students. Approvers can be faculty, parents, outside advisors or any combination thereof. When an approver logs on, an approver-specific screen is displayed. The features described under “1) All Users” (above) can be accessed, or the approver can go directly to the tasks they need to complete, by selecting an area on their screen (e.g. a button, graphic icon, menu item, tab or similar) that corresponds to the task Approvers' tasks are to approve student deliverables, or request rework. In certain cases (e.g. an approver is not available), one approver can approve deliverables on behalf of another.

Approver #1 receives an email message and a notification generated by the system 28 that a deliverable is ready for review. Approver #1 reviews the deliverable on-line and decides whether the deliverable is worthy of approval (based on factors such as whether sufficient research was conducted, spelling, grammar, compliance with education institution policies, guidelines and standards, logic, flow, etc).

If the deliverable is approved or requires rework, Approver #1 indicates this to the software tool, and adds reasons why rework is required. In addition to notifying the student (as discussed), Approver #n is notified 32 that the deliverable is ready for approval. Approver #n follows the same process as Approver #1, and the system handles notifications 34 as described for Approver #1. The student re-submits 36 the deliverable for approval. This is an iterative process that will occur until all Approvers approve the deliverable (as explained above). The software tool handles more than 2 approvers.

From a list on the screen, approvers can view their students, other approvers, administrators and the relationships between them (i.e. who is Approver #1, Approver #2, etc). They can view these users' contact information, and send emails to these users. Approvers can also select a student's name and immediately view that student's project status and deliverables.

4) Administrators

Administrators are at the program-level of project-based learning programs. When an administrator logs on, an administrator-specific screen is displayed. The features described under “1) All Users” (above) can be accessed, or the administrator can go directly to the tasks they need to complete, by selecting an area on their screen (e.g. a button, graphic icon, menu item, tab or similar) that corresponds to the task

Administrators are responsible for the following tasks:
a) Create and maintain due dates for student deliverable submissions and approvals. Administrators are prompted by the system to enter the due dates for students' deliverable submissions (Project Topic Submission, Project Plan, Project Status Reports, and Final Report). They are also prompted to enter the due dates for completion of each approver's approvals. The software tool automatically notifies students of deliverable submission dates, and approvers of approval dates. In addition, all dates are displayed on all users' calendar feature.
b) Administrators can monitor the performance of their institution's project-based learning program at any time. This feature enables them to select and produce one or more reports (e.g. average cost of student projects, number of students with past due deliverables, etc) from a list of pre-defined reports displayed on the screen.
c) Administrators can electronically create and maintain the institution's program policies, guidelines, standards, assessment criteria and other related information. This information is available on-line to all users.
d) Administrators can electronically create and maintain the security, names and relationships of all users in the system. Since project participants can change frequently (e.g. class sizes change, faculty and students move in or out of the institution, etc), this feature enables those changes to be reflected in the system.
e) Administrators can also select from a list and view all approvers, and the students for whom they are responsible. This feature enables class sizes to be monitored.
f) Administrators can select form a list and view all students' deliverables and their status. This feature enables approvers (i.e. the supervisory-level) to be monitored, by displaying information on deliverable quality, plus submission and approval timeliness.
g) At the end of the project year, administrators can prepare an archive of student project work. This feature covers the entire history of all students' deliverables, approvers' comments, reworks (if any), and other project-related information stored in the system. The information can be saved to a Compact Disc or similar media for future reference and as a defense against legal challenges to a “fail” grade. It also enables the institution to re-use student project topic and project summary information for research purposes by future students.
   CONCLUSION, RAMIFICATION AND SCOPE

From the description above, the reader will see a number of advantages of this system over previous methods:
a) Students' project information, together with histories of comments by approvers and others, reside in one place, easily accessible and archived by authorized users at any time. With previous methods, significant time is spent by project participants in administering forms and other pieces of project-related information. In addition, not all information is centrally located and/or easy to access.
b) The system's built-in messaging features between project participants, plus its links to email significantly enhances communication. Previous methods of communication (paper, email, bulletins, etc) are inconsistently used, resulting in project participants not always being “on the same page.”
c) Student projects are automatically tracked from start to conclusion, with work-in-progress monitored at any time by authorized users. Previous project tracking methods (meetings, mailings, printing hard-copy, keeping records, etc) are time-consuming, inconsistent and difficult to manage.
d) Access to project information is significantly enhanced because the software tool is designed to operate on the internet. Previous access methods are manual, or enjoy limited computer support, resulting in poor or difficult access to project information.
e) The approval process is automated, with approvers automatically notified of project status. Previous methods (meetings, mailing, printing hard-copy, keeping records, etc) are inconsistent and time-consuming.
f) Due dates for deliverables and approvals are displayed in a status feature and in a calendar feature, for all users. Previous methods (bulletins, announcements, brochures, flyers, etc) are inconsistent, and time-consuming to manage, resulting in some participants missing important deadlines.
g) Institution information is easily accessible to all users. Previous methods (bulletins, announcements, brochures, flyers, etc) are time-consuming, inconsistent and difficult to manage.
h) The system's functionality is based on proven project management principles, enabling students to learn by example, life-long skills. Previous programs are not all grounded in such principles, resulting in students who are less prepared for business or further academic pursuits.
i) Secure access to information is ensured by unique user identification and passwords. Previous methods typically lack strong security measures, and information integrity can be compromised.
j) Research capability and connection to a plagiarism scanning feature enable students and approvers to generate ideas, without stealing other peoples' work. Previous methods relied on the student to generate ideas by other means, and plagiarism is difficult to detect and prove.
k) Archiving of students' deliverables and associated work, plus approvers comments provides the institution with easily accessible documentation with which to defend legal and other challenges to poor student grades.

Although the description above contains much specificity, this should not be construed as limiting the scope of the invention. Rather, it communicates the functionality and flexibility of the software tool to the reader. The scope of my invention should be determined by the following claims and their legal equivalents, rather than by the above mentioned examples.

1. An Internet based method for tracking and managing student project work in a three-level environment including an institutional level, a supervisory level and a student level wherein students select projects and prepare deliverable information for review and/or approval by persons at the supervisory level, and wherein requirements are imposed on said projects by the institutional level such as project guidelines and assessment criteria, comprising the steps:
providing a central computer memory for storage of information related to said projects,
providing means to allow said participating students and supervisors access to said information stored in said central computer memory,
providing means to authenticate the identity of participating students and supervisors,
providing, in said central storage, means for participating students and supervisors to submit, view, edit or delete deliverable information,
storing in said central storage the institutional criteria for said projects, including guidelines and projected deadlines for submission of deliverable information for each of said participating students,
storing in said central storage the actual, deliverable information submitted by participating students for each deadline, and date of submission,
providing means for automatically notifying participating supervisors when deliverable information has been submitted for approval, and
recording, storing and automatically notifying participating students of supervisory approval or disapproval.

2. The method of claim 1 comprising the further steps by each participating student:
delivering a topic submission report for approval,
delivering a project plan for approval,
delivering status reports for approval, and
delivering the final project for approval.

3. An Internet based method for tracking, managing and controlling educational projects wherein a plurality of participating students in an educational institution program are assigned one or more projects, said projects are to be planned and information delivered by said participating students for review and/or approval by participating faculty, parents and outside advisors, and wherein various institutional criteria must be met, namely, deadlines, budgets, and guidelines, comprising the steps:
providing a central computer memory for storage of information related to said projects,
providing means to allow said participating students, faculty, parents and outside advisors access to said information stored in said central computer memory,
providing means to authenticate the identity of participating students, faculty and outside advisors,
providing, in said central storage, means for participating students, faculty,
parents and outside advisors to submit, view, edit or delete deliverable information,
storing in said central storage the institutional criteria for said projects, including projected deadlines for submission of deliverable information for each of said participating students,
storing in said central storage the actual, deliverable information submitted by participating students for each deadline, and date of submission,
providing means for automatically notifying participating faculty, parents and outside advisors when deliverable information has been submitted for approval, and
recording, storing and automatically notifying participating students of faculty approval or disapproval and feedback comments from parents and outside advisors.
